(19) United States
(12) Patent Application Publication
(10) Pub. No.: US 2007/0138963 A1
(43) Pub. Date: Jun. 21, 2007

(54) Ceramic arc chamber having shaped ends

(75) Inventors: Timothy D. Russell, North Ridgeville, OH (US); Lei Deng, Richmond Heights, OH (US); James A. Leonard, Shaker Heights, OH (US); Thomas Boyle, Lyndhurst, OH (US)

Correspondence Address: PEARNE & GORDON LLP, 1801 EAST 9TH STREET, SUITE 1200, CLEVELAND, OH, 44114-3108, US

(73) Assignee: General Electric Company

(21) Appl. No.: 11/311,111

(22) Filed: Dec. 19, 2005

(51) Int. Cl. H01J 61/30; H01J 17/16; H01J 63/04

(52) U.S. Cl. 313/634; 313/573; 313/493

(57) ABSTRACT

Arc chambers for discharge lamps, such as ceramic metal halide lamps, have ends, where the electrodes for the arc chambers are introduced, that are configured such that, when the arc chambers are arranged vertically, the metal halide additives in the arc chambers will accumulate substantially only on the inner surfaces of the ends, which can have closure walls that are thicker than the thickness of the walls of the body portions of the arc chambers. The ends can be further configured such that the metal halides are deposited substantially uniformly in a thin layer over the ends of the arc chambers. The ends can also be configured in a manner that no sharp edges are provided at the ends of the arc chambers so that corrosive effects to the arc chamber resulting from localized temperature variations are minimized.

### BACKGROUND OF THE INVENTION

The present invention relates generally to arc chambers for discharge lamps such as ceramic metal halide lamps and, in particular, the invention concerns the construction, shape and configuration of the ends of ceramic arc chambers where the electrodes for the chambers are introduced into the chambers.

Discharge lamps, such as ceramic metal halide lamps, produce light by the ionization of a filler material, such as a mixture of metal halide additives and mercury, that is vaporized when the lamp is turned on. The ionization takes place in a transparent or translucent discharge chamber that is formed of a ceramic material such as polycrystalline alumina for example. The discharge chamber, often referred to as an arc tube or arc chamber, contains electrodes that are adapted to be connected to an electric circuit. When the electric circuit is energized, an electric arc is established between the electrodes and the filler material is thereby vaporized and ionized and light generated.

The ceramic arc tube or chamber can be of a variety of shapes such as cylindrical, spherical or oblate for example. In the case of a cylindrically-shaped arc tube, the arc tube can comprise a continuous outer wall that can be somewhat elongated. The opposed ends of the arc tube can be closed off with ceramic end pieces. In that case, a respective ceramic leg is attached to each end piece and a respective electrode is inserted through an opening in the leg and a complementary opening in the end piece so that the tip of the electrode will be positioned within the space surrounded by the continuous outer wall of the arc tube. As a result, the tips of the electrodes will be facing one another and will be appropriately positioned to establish an arc between each other when the electrodes are energized.

When in use, the arc chamber may be arranged so that the electrodes assume a vertical orientation, with one end of the arc chamber and an accompanying electrode and end piece situated below the other end of the chamber and an accompanying electrode and end piece. The lower end of the arc chamber in such an orientation typically comprises the coolest region of the arc chamber so that it is the region where the metal halide additives tend to collect.

The metal halide additives that are used in the filler material often comprise rare earth halides. It is the case that the metal halide additives, and particularly the rare earth halide additives, are corrosive to ceramic materials such as polycrystalline alumina and the corrosion caused by the additives can result in premature failure of the ceramic arc tube. This circumstance is exacerbated where the temperature gradients that are created at the end piece at the bottom of the arc tube are such as to cause the metal halide additives to collect on the bottom end piece and against the outer wall of the arc tube where the outer wall of the arc tube is joined to the bottom end piece. Alumina from the inside surface of the outer wall is dissolved by the additives thereby causing the arc tube to fail. Increasing the thickness of the outer wall is not a satisfactory solution because doing so decreases the lumen output of the lamp.

Other difficulties associated with ceramic arc chambers, whether they are vertically or horizontally oriented, involve bowing of the arc chambers and cracking of the arc chambers. It would be of benefit to have available ceramic arc chambers that avoided these problems.

### SUMMARY OF THE INVENTION

According to one aspect, the invention concerns a ceramic arc chamber for a discharge lamp comprising a body portion having a continuous outer wall that includes an outer surface and an inner surface and that surrounds a space adapted to contain electrodes and metal halide additives. The continuous outer wall includes a first end and a second end that are spaced longitudinally from one another and define the longitudinal extent of the continuous outer wall. At least the first end of the continuous outer wall has an opening into the space that is surrounded by the continuous outer wall. An end piece is located in the opening in the first end of the continuous outer wall and is joined to the inner surface of the continuous outer wall. The end piece has a closure wall that is arranged generally axially of the longitudinal extent of the continuous outer wall and an outer surface and an inner surface that faces the space surrounded by the continuous outer wall. The inner surface of the continuous outer wall of the body portion and the inner surface of the closure wall of the end piece are configured so as to merge in a manner such that their line of merger and the inner surface of the closure wall otherwise do not provide any sharp edges at the ends of the ceramic arc chamber adjacent the first end of the continuous outer wall.

According to a further aspect, the invention concerns a ceramic arc chamber for a discharge lamp comprising a body portion and at least one particularly configured end piece. The body portion has a continuous outer wall that includes an outer surface and an inner surface and that surrounds a space adapted to contain electrodes and metal halide additives. The continuous outer wall includes a first end and a second end that are spaced longitudinally from one another and that define the longitudinal extent of the continuous outer wall. The body portion is adapted to be arranged when in use so that the longitudinal extent of the continuous outer wall is positioned in a manner that the first end of the continuous outer wall is located below the second end of the continuous outer wall. At least the first end of the continuous outer wall has an opening into the space that is surrounded by the continuous outer wall. An end piece is located in the opening in the first end of the continuous outer wall and is joined to the inner surface of the continuous outer wall. The end piece has a closure wall that is arranged generally axially of the longitudinal extent of the continuous outer wall and has a thickness greater than the thickness of the continuous outer wall. The end piece has an outer surface and an inner surface that faces the space surrounded by the continuous outer wall. The inner surface of the continuous outer wall of the body portion and the inner surface of the closure wall of the end piece are configured such that they merge together in a manner so that the metal halide additives will accumulate substantially only on the inner surface of the closure wall and the significant deleterious accumulation of the metal halide additives against the inner surface of the outer wall of the body portion of the ceramic arc chamber is prevented.

According to a particular aspect, the configuration of the inner surface of the closure wall is such as to establish a thermal profile between the first end and the second end of the arc tube that causes the metal halide additives to be deposited substantially uniformly over the inner surface of the closure wall of the end piece.

According to another aspect, the inner surface of closure wall of the end piece includes an inclined portion and a portion that is arranged inwardly of the inclined portion, in relation to the space that is surrounded by the continuous outer wall, and below the inclined portion when the ceramic arc chamber is arranged for use. The inclined portion essentially joins the inner surface of the continuous outer wall to the portion of the inner surface of the closure wall that is arranged inwardly of the inclined portion and below the inclined portion.

According to a further aspect, the inner surface of the closure wall of the end piece is curvilinear in profile. The curvilinear profile of the inner surface of the closure wall extends inwardly from the inner surface of the continuous outer wall, in relation to the space surrounded by the outer wall of the body portion, and downwardly when the ceramic arc chamber is arranged for use.

According to still another aspect, the inner surface of the closure wall of the end piece has a spherical configuration that extends inwardly from the inner surface of the continuous outer wall, in relation to the space surrounded by the continuous outer wall, and downwardly when the ceramic arc chamber is arranged for use. In a particular embodiment, the outer surface of the closure wall of the end piece has a substantially conical configuration.

In yet a further aspect, the outer surface and the inner surface of the continuous outer wall are substantially cylindrical.

In yet another aspect, the first end of the continuous outer wall includes a terminal portion that forms a support for the end piece. The end piece includes a flange portion that extends axially outwardly of the longitudinal extent of the continuous outer wall and rests on the terminal portion of the continuous outer wall.

In still a further aspect, the end piece comprises an injection molding end piece.

In yet a further aspect, each of the first end and the second end of the continuous outer wall has an opening into the space that is surrounded by the continuous outer wall and similar respective end pieces are located in the openings so that either the first end or the second end of the continuous outer wall can be located below the other when the ceramic arc chamber is arranged for use.

### BRIEF DESCRIPTION OF THE DRAWINGS

FIG. 1 is an exploded elevational view in cross-section of a first embodiment of the invention.

FIG. 2 is an exploded elevational view in cross-section of a second embodiment of the invention.

FIG. 3 is an exploded elevational view in cross-section of a third embodiment of the invention.

### DESCRIPTION OF SEVERAL EMBODIMENTS OF THE INVENTION

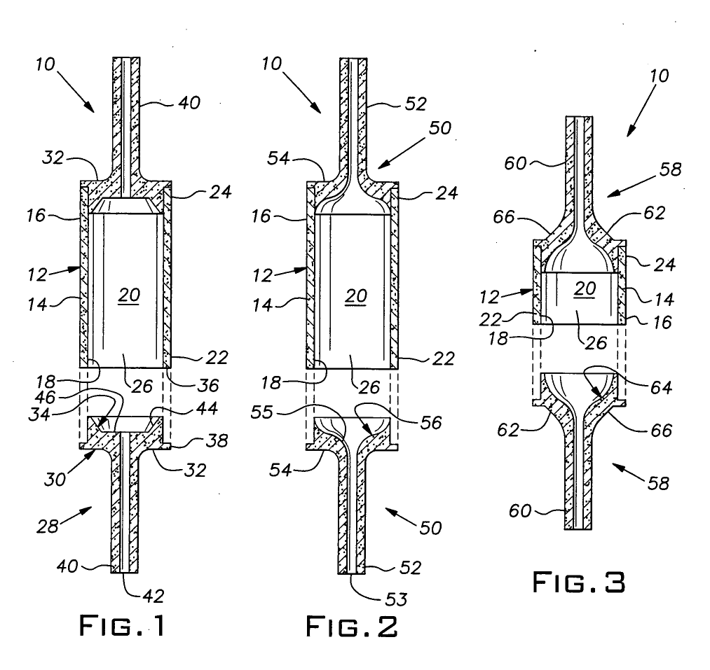

FIGS. 1, 2 and 3 illustrate three respective embodiments of the invention. Referring first to FIG. 1, an arc chamber, indicated generally at 10, for a discharge lamp, such as a ceramic halide lamp and made of a material such as polycrystalline alumina comprises a body portion, indicated generally at 12. The body portion 12 has a continuous outer wall 14 that includes an outer surface 16 and an inner surface 18 and that surrounds a space, indicated generally at 20. As described in more detail below, the space 20 is adapted to contain electrodes and metal halide additives, not shown.

The continuous outer wall 14 includes a first end 22 and a second end 24 that are spaced longitudinally from one another and that define the longitudinal extent of the continuous outer wall. When in use, the arc chamber 10 is placed in the manner illustrated in FIG. 1. Consequently, the body portion 12 is adapted to be arranged when in use so that the longitudinal extent of the continuous outer wall 14 is positioned in a manner that the first end 22 of the continuous outer wall is located below the second end 24 of the continuous outer wall.

At least the first end 22 of the continuous outer wall 14 has an opening 26 into the space 20 that is surrounded by the continuous outer wall. In the embodiment of the invention shown in FIG. 1, the second end 24 of the continuous outer wall 14 has an opening that is similar to the opening 26 but the opening at the second end 24 is illustrated as closed off by an end piece as will be described in greater detail below.

Giving attention to the first end 22 of the continuous outer wall 14 and the opening 26 located thereat, it can be seen that the opening 26 is adapted to receive an end piece, indicated generally at 28, which in the exploded view of FIG. 1, is shown as removed from the opening 26. When assembled, the end piece 28 is located in the opening 26 in the first end 22 of the continuous outer wall 14 and is joined to the inner surface 18 of the continuous outer wall. Typically, the end piece 28 is made of the same ceramic material as the body portion 12, and the end piece 28 is joined to the inner surface 18 of the continuous outer wall 14 by fusing the two components together such as by a sintering process. The end piece and the continuous outer wall can be joined together by other processes as well, as will be familiar to those having ordinary skill in the art.

The end piece 28 has a closure wall 30 that is arranged generally axially of the longitudinal extent of the continuous outer wall 14. The closure wall has a thickness greater than the thickness of the continuous outer wall 14, as can be seen in FIG. 1. The closure wall 30 has an outer surface 32 and an inner surface 34 that faces the space 20 that is surrounded by the continuous outer wall 14.

The first end 22 of the continuous outer wall 14 includes a terminal portion 36 that forms a support for the end piece 28, and the end piece includes a flange portion 38 that extends axially outwardly of the longitudinal extent of the continuous outer wall 14 and rests on the terminal portion 36 of the continuous outer wall. In the embodiment of FIG. 1, the structures of the second end 24 of the continuous outer wall 14 and the end piece 28 joined to the second end 24 are similar to that described for the first end 22 of the continuous outer wall and the end piece 28 adapted to be joined to the first end 22. In one aspect the end pieces can comprise injection molding pieces although the end pieces can be otherwise formed such as by pressing of machining, for example.

The end pieces 28 also include ceramic legs 40 that are fixed to the closure wall 30. As shown in FIG. 1, these legs are substantially narrower than the width of the closure wall 30 and, as will be understood by those of ordinary skill in the art, support the electrodes, not shown, that are used with the arc chamber 10. In general it can be noted that the tips of the electrodes are located within the space 20 and extend through the closure wall 30 and into the opening 42 in the legs 40 where they are held and sealed in place by a ceramic frit, a seal-glass, or a cermet for example.

As noted above, each of the first end 22 and the second end 24 of the continuous outer wall 14 has an opening into the space 14 that is surrounded by the continuous outer wall. And in the embodiment illustrated in FIG. 1, similar respective end pieces 28 are located in the openings so that either the first end 22 or the second end 24 of the continuous outer wall 14 can be located below the other when the ceramic arc tube 10 is arranged for use. Typically, the ceramic arc tube when in use will be arranged so that the end pieces 28 are vertically aligned as shown in FIG. 1.

The ends of the electrodes opposite the electrode tips extend beyond the ends of the legs 40 and are connected to an electric circuit that can be connected to a source of electric power for the purpose of energizing the electrodes. As indicated above, when the electrodes are energized, an electric arc is established between the electrode tips. The electric arc vaporizes and ionizes the filler material in the arc chamber, including the metal halides, such as rare earth halides that form a part of the filler material, and light is thereby generated. The filler material, including the metal halides, will condense and fall to the first end 22 of the arc chamber 10.

As previously noted, the metal halides are corrosive and can cause the arc tube to fail. This is particularly the case if the metal halides are permitted to accumulate in a way that they contact the inside surface 18 of the outer wall 14 which typically is relatively thin. Accordingly, the invention provides for lessening the opportunity for the metal halides to accumulate in a manner to cause the arc tube to readily fail. Generally speaking, to accomplish this result, the inner surface 18 of the continuous outer wall 14 of the body portion 12 and the inner surface 34 of the closure wall 30 of the end piece 28 are configured such that they merge together in a manner so that the metal halide additives will accumulate substantially only on the inner surface 34 of the closure wall 30 and be spread over a large area in a thin layer, and the significant deleterious accumulation of the metal halide additives against the inner surface 18 of the continuous outer wall 14 of the body portion 12 of the ceramic arc chamber 10 is prevented.

The foregoing result is accomplished in the embodiment of FIG. 1 as follows. The inner surface 34 of the closure wall 30 includes an inclined portion 44 and a portion 46 that is arranged inwardly of the inclined portion 44, in relation to the space 20 that is surrounded by the continuous outer wall 14, and below the inclined portion when the ceramic arc chamber 10 is arranged for use as illustrated in FIG. 1. The inclined portion 44 essentially joins the inner surface 18 of the continuous outer wall 14 to the portion of the inner surface 46 of the closure wall 30 that is arranged inwardly of the inclined portion 44 and below the inclined portion. As a result, the metal halides as they settle to the first end 22 of the ceramic arc tube, will not accumulate in a way that they significantly engage the inside surface 18 of the outer wall. Rather, they will tend to strike the inclined surface 44 and remain there or flow down to the portion of the inside surface 46. The closure wall being thicker than the thickness of the outer wall 14 will better withstand the corrosive action of the metal halides than the thinner outer wall.

The second embodiment of the invention shown in FIG. 2 includes a body portion 12 like the body portion of the embodiment of the invention shown in FIG. 1. In addition, the second embodiment of the invention includes end pieces 50 that close off the ends 22 and 24 of the body portion 12, and the end pieces are provided with legs 52 to support electrodes, the tips of which are disposed within the space 20 surrounded by the outer wall 14 of the body portion 12. Also, the end pieces 50 include closure walls 54 arranged axially of the longitudinal extent of the outer wall 14 and the closure walls are thicker than the thickness of the outer wall.

A difference between the embodiment of FIG. 1 and the embodiment of FIG. 2 is the configuration of the inner surface of the closure wall. In the embodiment of FIG. 2, the inner surface of the closure wall is curvilinear in profile and the curvilinear profile 56 of the inner surface of the closure wall extends inwardly from the inner surface 18 of the continuous outer wall 14, in relation to the space 20 surrounded by the outer wall of the body portion 12, and downwardly when the ceramic arc chamber 10 is arranged for use. Thus, the line of merger between the inner surface of the closure wall and the inner surface of the continuous outer wall does not provide a sharp edge where a temperature minima can be established. Additionally, the transition area 55 between the inner surface of the closure wall and the wall of the opening 53 in the leg 52 is curvilinear. Because the end of the arc chamber adjacent the first end of the continuous outer wall is thereby devoid of sharp edges, corrosive effects are minimized. The metal halides will tend to collect on the inner surface of the closure wall in a thin layer over a large surface area, and, in the embodiment of FIG. 2, that is where the closure wall is essentially the thickest.

The third embodiment of the invention shown in FIG. 3 includes a body portion 12 like the body portions of the embodiments of the invention shown in FIGS. 1 and 2. However, the lengths of the body portion 12 of the embodiment of FIG. 3 is somewhat shorter than the lengths of the body portions 12 of the embodiments of FIGS. 1 and 2 for reasons explained below. The third embodiment of the invention also includes end pieces 58 that close off the ends of the body portion 14, and the end pieces are provided with legs 60 to support electrodes, the tips of which are disposed within the space 20 surrounded by the outer wall 14 of the body portion 12. Additionally, the end pieces 58 include closure walls 62 arranged axially of the longitudinal extent of the outer wall 14 and the closure walls 62 are thicker than the thickness of the outer wall 14.

A difference between the embodiment of FIG. 3 and the embodiment of FIG. 2, on the one hand, and the embodiment of FIG. 1, on the other hand, is the configuration of the inner surface 64 of the closure wall 62. In the embodiment of FIG. 3, the inner surface 64 of the closure wall 62 has a spherical configuration that extends inwardly from the inner surface 18 of the continuous outer wall 14, in relation to the space 20 surrounded by the outer wall 14 of the body portion 12, and downwardly when the ceramic arc chamber is arranged for use. As with the embodiment of FIG. 2, the condensed metal halides will tend to collect on the inner surface 64 of the closure wall where the closure wall is essentially the thickest because the end pieces are devoid of the sharp edges, such as where the inner surfaces of the outer wall and the closure wall merge and where the inner surface of the closure wall transitions to the wall of the opening in the leg 60, that promote corrosion. An additional distinction of the embodiment of FIG. 3 is that the outer surface 66 of the closure wall has a substantially conical configuration. This configuration provides benefits related to handling, manufacturability and corrosion. The spherical configuration of the inner surface 64 of the closure wall 62 provides additional volume within the arc chamber of the embodiment shown in FIG. 3. As a result, and because there can be a desire to maintain the internal volumes of all three arc chambers approximately equal, the length of the body portion 12 of the embodiment of FIG. 3 is shorter than the lengths of the body portions 12 of the embodiments of FIGS. 1 and 2 in that instance.

The feature of the embodiments of FIGS. 2 and 3 whereby the configuration of the inner surfaces 56 and 64 of the closure walls is devoid of sharp edges results in the establishment of a thermal profile between the first end 22 and the second end 24 of the arc tube 10 that causes the metal halide additives to be deposited substantially uniformly over the respective inner surfaces 56 and 64 of the closure wall of the end piece at the first end 22 of the outer wall 14 of the body portion 12 of the arc tube 10. This facilitates the collection of the metal halides away from the inside surface 18 of the outer wall 14. The configurations of the inner surfaces of the closure walls of the embodiments of FIGS. 2 and 3 are examples of configurations that have this property but other configurations, as will occur to those having ordinary skill in the art can produce the same result.

The feature of the embodiments of FIGS. 2 and 3 whereby the inner surface 18 of the continuous outer wall 14 of the body portion 12 and the inner surface 56 of the closure wall 54 of the end piece 50, as well as the inner surface 64 of the closure wall 62 of the end piece 58, are configured so as to merge in a manner such that their line of merger, and the inner surfaces 56 and 64 of the closure walls 54 and 62, respectively, do not provide any sharp edges and the transition areas between the inner surfaces of the closure walls and the walls of the openings in the legs that support the electrodes do not provide sharp edges allows the invention to be applied in embodiments where the ceramic arc tube is arranged in any orientation between vertical and horizontal and in embodiments where the closure wall of the end piece is not thicker than the thickness of the outer wall of the body portion.

The deposition of the metal halides as has been described above, particularly with reference to FIGS. 2 and 3, occurs so that the deposition takes place over a substantially uniform area. This results in improvements in lamp performance due to increased mass transport of the metal halides into the arc established between the electrodes.

In each of the embodiments of the invention shown in FIGS. 1, 2 and 3, the outer surface 16 and the inner surface 18 of the continuous outer wall 14 of the body portion 12 of the arc chamber 10 are illustrated as being substantially cylindrical. However, these surfaces can take other shapes. For example, the surfaces can be spherical or oblate.

The embodiments described above, particularly the embodiments illustrated in FIGS. 2 and 3, can provide improvements in addition to those previously set forth. Thus, improvements are obtainable in lumens per watt, the color rendering index and the correlated color temperature for vertical and horizontal orientation of the ceramic arc tube.

Although the invention has been described with respect to certain embodiments thereof, it will be recognized by those skilled in the art that the invention can be practiced with modifications that are within the spirit and the scope of the claims that follow. For example, the ceramic arc chamber is not limited to a three-piece construction but can be constructed of two, five or any number of pieces as will be understood by those skilled in the art.

What is claimed is:

1. A ceramic arc chamber for a discharge lamp comprising;
a body portion having a continuous outer wall that includes an outer surface and an inner surface and that surrounds a space adapted to contain electrodes and metal halide additives, the continuous outer wall including a first end and a second end that are spaced longitudinally from one another and define the longitudinal extent of the continuous outer wall, and at least the first end of the continuous outer wall has an opening into the space that is surrounded by the continuous outer wall; and
an end piece located in the opening in the first end of the continuous outer wall and joined to the inner surface of the continuous outer wall, the end piece having a closure wall that is arranged generally axially of the longitudinal extent of the continuous outer wall, and having an outer surface and an inner surface that faces the space surrounded by the continuous outer wall, the inner surface of the continuous outer wall of the body portion and the inner surface of the closure wall of the end piece being configured so as to merge in a manner such that their line of merger and the inner surface of the closure wall otherwise do not provide any sharp edges at the end of the arc chamber adjacent the first end of the continuous outer wall.

2. The ceramic arc chamber of claim 1 wherein the closure wall of the end piece located in the opening in the first end of the continuous outer wall is of a thickness greater than the thickness of the continuous outer wall.

3. The ceramic arc chamber of claim 1 wherein the inner surface of the closure wall is curvilinear in profile and the curvilinear profile of the inner surface of the closure wall extends inwardly from the inner surface of the continuous outer wall, in relation to the space surrounded by the outer wall of the body portion, and away from the space surrounded by the outer wall of the body portion.

4. The ceramic arc chamber of claim 1 wherein the inner surface of the closure wall of the end piece has a spherical configuration that extends inwardly from the inner surface of the continuous outer wall, in relation to the space surrounded by the continuous outer wall, and away from the space surrounded by the outer wall of the body portion.

5. The ceramic arc chamber of claim 4 wherein the outer surface of the closure wall has a substantially conical configuration.

6. The ceramic arc chamber of claim 5 wherein the outer surface and the inner surface of the continuous outer wall are substantially cylindrical.

7. The ceramic arc chamber of claim 6 wherein the first end of the continuous outer wall includes a terminal portion that forms a support for the end piece and the end piece includes a flange portion that extends axially outwardly of the longitudinal extent of the continuous outer wall and rests on the terminal portion of the continuous outer wall.

8. The ceramic arc chamber of claim 7 wherein the end piece comprises an injection molding end piece.

9. The ceramic arc chamber of claim 1 wherein the body portion is adapted to be arranged when in use so that the longitudinal extent of the continuous outer wall is positioned in a manner such that the first end of the continuous outer wall is located below the second end of the continuous outer wall and the configuration of the inner surface of the closure wall is such as to establish a thermal profile over the first end of the ceramic arc chamber that causes the metal halide additives to be deposited substantially uniformly over the inner surface of the closure wall of the end piece.

10. The ceramic arc chamber of claim 9 wherein the inner surface of the closure wall is curvilinear in profile and the curvilinear profile of the inner surface of the closure wall extends inwardly from the inner surface of the continuous outer wall, in relation to the space surrounded by the outer wall of the body portion, and downwardly when the ceramic arc chamber is arranged for use.

11. The ceramic arc chamber of claim 10 wherein the inner surface of the closure wall of the end piece has a spherical configuration that extends inwardly from the inner surface of the continuous outer wall, in relation to the space surrounded by the continuous outer wall, and downwardly when the ceramic arc chamber is arranged for use.

12. The ceramic arc chamber of claim 11 wherein the outer surface of the closure wall has a substantially conical configuration.

13. The ceramic arc chamber of claim 12 wherein the outer surface and the inner surface of the continuous outer wall are substantially cylindrical.

14. The ceramic arc chamber of claim 13 wherein the first end of the continuous outer wall includes a terminal portion that forms a support for the end piece and the end piece includes a flange portion that extends axially outwardly of the longitudinal extent of the continuous outer wall and rests on the terminal portion of the continuous outer wall.

15. The ceramic arc chamber of claim 14 wherein the end piece comprises an injection molding end piece.

16. A ceramic arc chamber for a discharge lamp comprising:
a body portion having a continuous outer wall that includes an outer surface and an inner surface and that surrounds a space adapted to contain electrodes and metal halide additives, the continuous outer wall including a first end and a second end that are spaced longitudinally from one another and define the longitudinal extent of the continuous outer wall, the body portion adapted to be arranged when in use so that the longitudinal extent of the continuous outer wall is positioned in a manner that the first end of the continuous outer wall is located below the second end of the continuous outer wall, and at least the first end of the continuous outer wall has an opening into the space that is surrounded by the continuous outer wall; and
an end piece located in the opening in the first end of the continuous outer wall and joined to the inner surface of the continuous outer wall, the end piece having a closure wall that is arranged generally axially of the longitudinal extent of the continuous outer wall, having a thickness greater than the thickness of the continuous outer wall and having an outer surface and an inner surface that faces the space surrounded by the continuous outer wall, the inner surface of the continuous outer wall of the body portion and the inner surface of the closure wall of the end piece being configured such that they merge together in a manner so that the metal halide additives will accumulate substantially only on the inner surface of the closure wall and the significant deleterious accumulation of the metal halide additives against the inner surface of the continuous outer wall of the body portion of the ceramic arc chamber is prevented.

17. The ceramic arc chamber of claim 16 wherein each of the first end and the second end of the continuous outer wall has an opening into the space that is surrounded by the continuous outer wall and similar respective end pieces are located in the openings so that either the first end or the second end of the continuous outer wall can be located below the other when the ceramic arc chamber is arranged for use.

18. The ceramic arc chamber of claim 16 wherein the inner surface of the closure wall includes an inclined portion and a portion that is arranged inwardly of the inclined portion, in relation to the space that is surrounded by the continuous outer wall, and below the inclined portion when the ceramic arc chamber is arranged for use, and the inclined portion essentially joins the inner surface of the continuous outer wall to the portion of the inner surface of the closure wall that is arranged inwardly of the inclined portion and below the inclined portion.

19. The ceramic arc chamber of claim 18 wherein each of the first end and the second end of the continuous outer wall has an opening into the space that is surrounded by the continuous outer wall and similar respective end pieces are located in the openings so that either the first end or the second end of the continuous outer wall can be located below the other when the ceramic arc chamber is arranged for use.

20. The ceramic arc chamber of claim 16 wherein the inner surface of the closure wall is curvilinear in profile and the curvilinear profile of the inner surface of the closure wall extends inwardly from the inner surface of the continuous outer wall, in relation to the space surrounded by the outer wall of the body portion, and downwardly when the ceramic arc chamber is arranged for use.

21. The ceramic arc chamber of claim 20 wherein each of the first end and the second end of the continuous outer wall has an opening into the space that is surrounded by the continuous outer wall and similar respective end pieces are located in the openings so that either the first end or the second end of the continuous outer wall can be located below the other when the ceramic arc chamber is arranged for use.

22. The ceramic arc chamber of claim 16 wherein the inner surface of the closure wall of the end piece has a spherical configuration that extends inwardly from the inner surface of the continuous outer wall, in relation to the space surrounded by the continuous outer wall, and downwardly when the ceramic arc chamber is arranged for use.

23. The ceramic arc chamber of claim 22 wherein the outer surface of the closure wall has a substantially conical configuration.

24. The ceramic arc chamber of claim 23 wherein each of the first end and the second end of the continuous outer wall has an opening into the space that is surrounded by the continuous outer wall and similar respective end pieces are located in the openings so that either the first end or the second end of the continuous outer wall can be located below the other when the ceramic arc chamber is arranged for use.

25. The ceramic arc chamber of claim 16 wherein the configuration of the inner surface of the closure wall is such as to establish a thermal profile between the first end and the second end of the arc tube that causes the metal halide additives to be deposited substantially uniformly over the inner surface of the closure wall of the end piece.

26. The ceramic arc chamber of claim 25 wherein the inner surface of the closure wall is curvilinear in profile and the curvilinear profile of the inner surface of the closure wall extends inwardly from the inner surface of the continuous outer wall, in relation to the space surrounded by the outer wall of the body portion, and downwardly when the ceramic arc chamber is arranged for use.

27. The ceramic arc chamber of claim 25 wherein the inner surface of the closure wall of the end piece has a spherical configuration that extends inwardly from the inner surface of the continuous outer wall, in relation to the space surrounded by the continuous outer wall, and downwardly when the ceramic arc chamber is arranged for use.

28. The ceramic arc chamber of claim 27 wherein the outer surface of the closure wall has a substantially conical configuration.

29. The ceramic arc chamber of claim 16 wherein the outer surface and the inner surface of the continuous outer wall are substantially cylindrical.

30. The ceramic arc chamber of claim 16 wherein the first end of the continuous outer wall includes a terminal portion that forms a support for the end piece and the end piece includes a flange portion that extends axially outwardly of the longitudinal extent of the continuous outer wall and rests on the terminal portion of the continuous outer wall.

31. The ceramic arc chamber of claim 16 wherein the end piece comprises an injection molding end piece.
